(19) United States
(12) Patent Application Publication
(10) Pub. No.: US 2004/0178377 A1
(43) Pub. Date: Sep. 16, 2004

(54) Electromagnetic regulating device

(76) Inventors: Roland Schempp, Vaihingen (DE); Berthold Pfuhl, Markgroeningen (DE); Rainer Zwickel, Vaihingen (DE)

Correspondence Address: Douglas L Wathen, Gifford Krass Groh Sprinkle Anderson & Citkowski, Suite 400, 280 North Old Woodward, Birmingham, MI, 48009, US

(21) Appl. No.: 10/476,805

(22) PCT Filed: May 6, 2002
(86) PCT No.: PCT/DE02/01627

(30) Foreign Application Priority Data
May 4, 2001 (DE) 101-21-770.6

(51) Int. Cl. F16K 31/02

(52) U.S. Cl. 251/129.11

(57) ABSTRACT

The invention relates to an electromagnetic regulating device (1) for a hydraulic control valve, comprising a housing (14, 15, 32) which comprises an electromagnet rotor arranged in a pressure pipe (2). Additionally, a distance measuring system (6) which detects the lift of the rotor is provided. Said pressure pipe (2) comprises a central thread (3) on one end thereof for securing onto the control valve and is made of a rotor conduit (7) and a sensor pipe which is connect thereto in a tight and secure manner. Said rotor conduit (7) lifts the rotor and supports a magnetic coil (5). Said sensor pipe (8) comprises a sensor coil (21) for detecting the way. Securing means are also provided for components which are semi-mounted on the pressure pipe (2). In the area at the end of the rotor conduit (7) orientated towards the sensor pipes (7), a collar (13) for holding the components arranged on the rotor conduit is provided and is firmly secured to said rotor conduit (7), rising above said conduit.

### PRIOR ART

The invention relates to an electromagnetic regulating device based on the type more specifically defined in the heading of the patent claim 1.

A proportional magnet with distance measuring system is known from EP 0 278 227 B1, into which a pressure pipe is built, formed as a rotor pipe and sensor pipe in a housing. For this proportional magnet, a magnetic coil and a sensor coil from opposite ends are built into the housing. Four longitudinal bores and allocated bolts are provided in the housing to fasten the proportional magnet to the control valve. A housing encasing the distance measuring system is interrupted in the region of the distance measuring system, in order to implement an electric connection between the distance measuring system and the electronics corresponding with it.

However, the disadvantage is that use of a connecting rod for the electromagnetic regulating device with a control valve is expensive and unsatisfactory as far as the production technology.

DE 197 07 587 describes an electromagnetic regulating device in which a pressure pipe has a central winding in order to fasten the regulating device to a control valve. The components of a magnetic circuit and a distance measuring system are pushed to the end of the pressure pipe, which lies opposite the end on which the central winding is provided. In order to maintain a fixed arrangement of these components on the pressure pipe, these are fixed to the pressure pipe via an end plate of the casing in pre-tensioned assembly position.

The pressure pipe rises above the distance measuring system, and a housing lid is screwed onto a winding provided at one end of the pressure pipe to close the housing. The distance measuring system has an electric-conducting cable on the electronics system of the electromagnetic regulating device, which is conducted through a slit in the pressure pipe. However, the slit of the pressure pipe leads to a decrease in the stability of the pressure pipe, and the fasteners of the housing lid can lead to deformation of the slit.

An additional disadvantage is that the described embodiment of the pressure pipe with a slit and the outer winding provided to fasten the end plate cause high production costs, and the result is an expensive assembly process.

### ADVANTAGES OF THE INVENTION

In contrast, the electromagnetic regulating device based on the invention with the characteristics of patent claim 1 has the advantage that it has an especially simple assembly process to the control valve, since the pressure pipe is already placed into the magnetic coil while manufacturing the magnet, and the electromagnetic regulating device is thus present as a complete unit during the valve assembly, which is only bolted to the control valve.

An additional advantage is that the collar rising above the rotor conduit and being fixed to it takes directly of the function of holding the components at the pressure pipe, especially of the magnetic coil. This makes it possible to design the pressure pipe considerably shorter than the electromagnetic regulating device known from prior art, and it is possible to design the area between the distance measuring system and the electronics corresponding with it to be open enough that a slotted embodiment of the pressure pipe is not necessary. This leads to the benefit of a considerable reduction in manufacturing costs, and in addition, it simplifies the assembly, since an electronic connection of the sensor coil can be easily connected to the electronics without additional technical production.

Additional advantages and advantageous embodiments of the object of the invention can be seen in the description, the drawing and patent claims.

Two examples of the regulating device based on the invention are represented in the drawing and are more clearly explained in the following description.

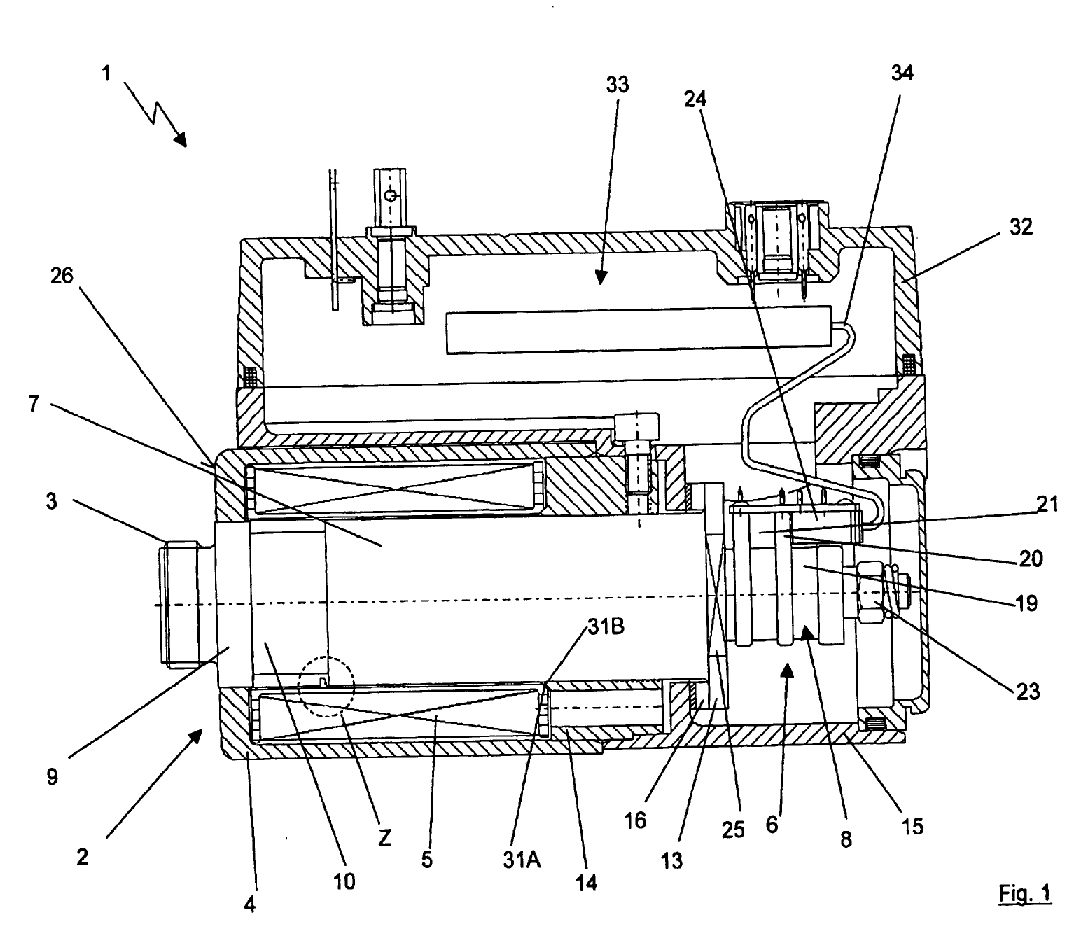

FIG. 1 shows a longitudinal section through an electromagnetic regulating device in simplified representation, whereby the collar is designed integrally with the pressure pipe;

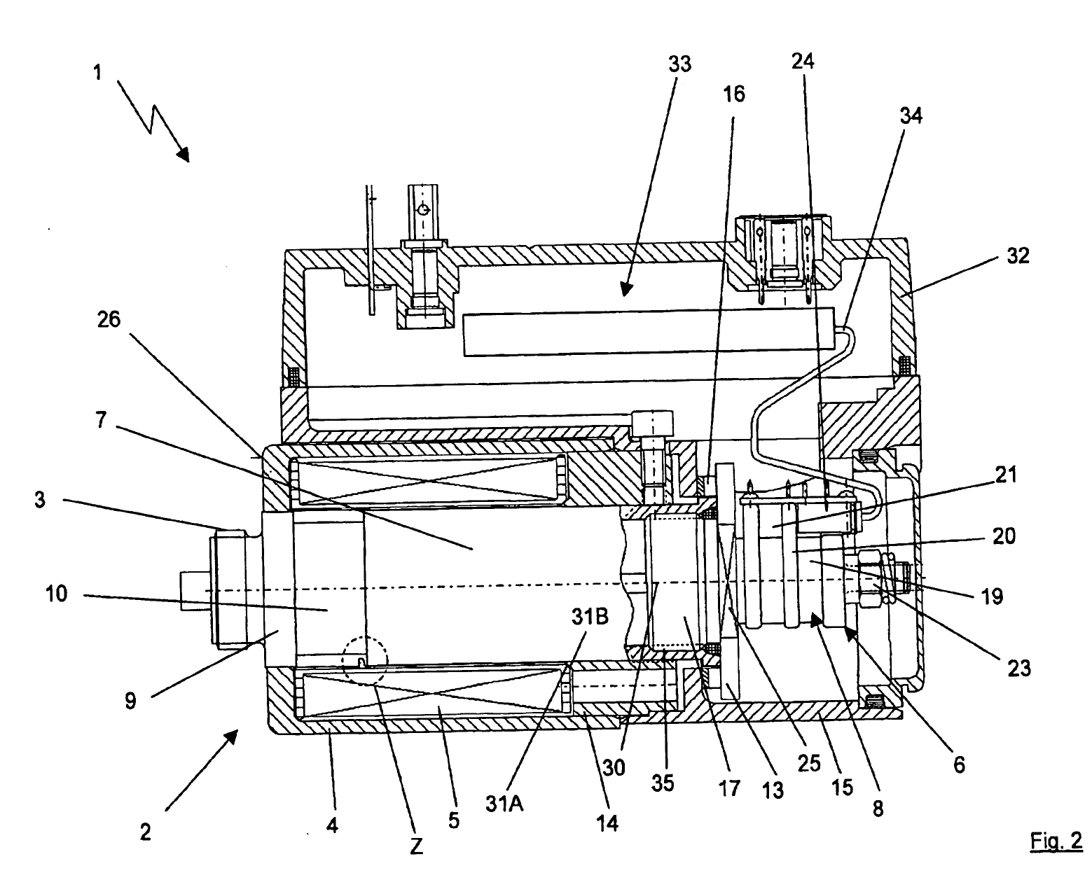

FIG. 2 shows a longitudinal cross-section through an electromagnetic regulating device in simplified representation, whereby the collar is designed as one piece with the sensor pipe; and

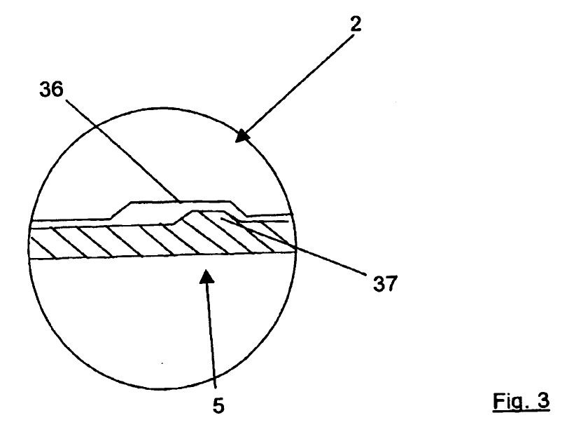

FIG. 3 shows an enlarged representation of the cutout Z from FIG. 2.

### DESCRIPTION OF THE EXECUTION EXAMPLE

FIG. 1 shows a longitudinal cross-section through an electromagnetic regulating device 1 in simplified representation, in which a pressure pipe 2 has a central thread 3 on its front, with which it is fastened to a valve casing (not shown in detail) or something similar. A shell 4 with magnetic coil 5, distance measuring system 6 and electronics 33 are pressed and fastened onto the pressure pipe 2.

The pressure pipe 2 is basically designed to be pressure-tight and is comprised of a rotor conduit 7 and a sensor pipe 8 fixed tightly into the rotor conduit 7. The rotor conduit 7 has a pole piece 9, onto which first surfaces 10 are arranged beside the central thread 3, and onto which a magnetic non-conductive first pipe part as well as a magnetic conductive second pipe part are connected.

The rotor conduit 7 has a collar 13 on its open free end, which serves to tension the components straddling the pressure pipe 2, so the magnetic coil 5, the shell 4 and a housing part 14. The collar is formed with the rotor conduit 7 in integral construction, and extends beyond it in radial direction. A spring 16 (not shown in further detail here) is installed between the collar 13 and the magnetic coil 5 or a housing 15 for tolerance compensation; this spring presses the collar 13 to the housing 15. In the present execution example, the spring 16 is designed as an undulated washer, which is supported in a projection of the housing 15, and which pre-tensions the components or individual parts of the magnetic circuit in their insertion positions, put on the pressure pipe 2.

The rotor conduit 7 retains the sensor pipe 8 in its interior, where it is concentrically guided along with a flange with enlarged thickness (not further described) into rotor conduit 7, and is fixed and tightly connected to it at a fastening location.

A pipe-shaped section 19 of the sensor pipe 8 extends out of the rotor conduit from the enlarged flange with a substantially smaller diameter compared to the rotor conduit 7. A coil carrier 20 with sensor measuring coil 21 is gliding at this section 19 on the outside, and an additional supporting spring is pressed against a nut 23 at the flange, which serves as adjusting means for the sensor coil 21.

The sensor coils 21 have pluggable electric connections 24, which are arranged on the outside diameter of the sensor coils 21. The outer diameter of the distance measuring system 6 is executed so that an assembly tool (not shown) can be conducted via this, and can be connected at second surfaces 25 of the collar 13, in order to bolt the electromagnetic regulating device 1 to a control valve. The housing of the control valve rests on a front 26 of the shell 4, wherewith the components put on the rotor conduit 7 are pre-tensioned by the collar.

Alternatively, instead of two surfaces 25, the collar 13 can also have recesses into which a suitable tool can be inserted; however, obviously the expert may also use his judgment to execute the device in a different suitable type and manner to correspond with an assembly tool.

A ferrite core of the inductively operating distance measuring system 6, which mechanically works with a rotor conducted into the pressure pipe 2, is arranged in a blind hole piece (not shown here) of the sensor pipe 8. The rotor, which is housed in the pressure pipe 2 between the pole piece 9 and the flange with enlarged thickness, is fixed with a tappet, which operates, for example, the valve slide of a distributing valve. In this manner, the pressure pipe has a continuously constant outer diameter starting from the central thread 3 to the collar 13, whereby its pipe parts are formed from a section of pipe whose thickness is continuously equal.

The cup-shaped shell 4 pressed onto the pressure pipe 2 accepts the magnetic coil 5 into its interior, and the ring space of the shell 4 opening towards the distance measuring system 6 is closed by the casing part 14. The shell 4 can be manufactured from round bars; however, obviously the expert may also use his judgment to form the shell 4 from a cost-effective deep-drawing part.

A seal is formed between the magnetic coil 5 and the casing part 14 from the inclines 31A, 31B which correspond to each other; whereby the angles of inclines 31A, 31B are provided so that there is a sealing line contact, which prevents the casting resin from flowing out of the magnetic coil, between inclines 31A, 31B when the regulating device 1 is assembled.

An additional housing part 32 is bolted to the housing 15, in which the electronics are arranged. The electronics 33 are arranged in the regulating device so that they are easily accessible and well protected, as well as sealed off. Multipolar cables 34 and plugs 24 (not all are shown) are provided to connect the magnetic coil 5 as well as the sensor coils 21 to the electronics 33.

How the regulating device 1 works is generally known. The distance measuring system compares the actual value of the rotor position in the pressure pipe 2 to the position target value stored in the electronics, and the rotor is controlled using the magnetic coil 5 until both values are the same.

FIG. 2 shows an additional type of embodiment for the electromagnetic regulating device 1, whereby this embodiment differs from the embodiment shown in FIG. 1 mainly in that the collar 13 is formed as one piece with the sensor pipe 8. In the description of FIG. 2, the same reference numbers are used for components with the same function as in the description of FIG. 1, and only the differences are explained.

In the embodiment of the electromagnetic regulating device 1 based on the presentation in FIG. 2, the sensor pipe 8 is not only formed as one piece with the collar 13, but it also forms an integral structural unit with the enlarged flange, which is formed as threaded nipple 17, and is screwed into the pressure pipe 2. Just as in FIG. 1 of the enlarged flange, the threaded nipple 17 also forms a stopper for the rotor 30.

The spring 16 is between the collar 13 and the housing 15 in axial direction of the regulating device 1 for tolerance compensation and for pre-tensioned insertion of the components straddling the pressure pipe 2.

This embodiment also provides the collar 13 with a device corresponding to an assembly tool, such as the surfaces 2 that are shown or alternatively with recesses for the assembly tool, to ease screwing the threaded nipple 1 or the flange with enlarged thickness respectively.

FIG. 3 is an enlarged representation showing the cutout Z based on FIGS. 1 and 2. The pressure pipe 2 has a recess 36 in the area of the magnetic coil 5 on its outer side, into which the magnetic coil extends with a projection 37 formed on its inner side, turned towards the pressure pipe 2. The recess 36 is formed as a trough in such a manner that the projection 37, that is designed as a plastic nipple of the magnetic coil, reaches inside, and so that the pressure pipe 2 with the assembled magnetic coil remains one constructive component with the control valve during transportation to final assembly. The recess 36 is larger or longer in axial direction than the projection 37, so that the magnetic coil 5 cannot be pushed onto the pressure pipe 2 in axial direction in untensioned assembly position.

Unlike both previously described embodiment examples of the electromagnet regulating device, it is possible to design the collar as one piece with a bushing, which is at least partially arranged on or in the rotor conduit. This makes it possible to fix the bushing to the rotor conduit via a bolt; the bushing either has an outer or inner threading, depending on whether the bushing is on or in the rotor conduit. Thus the collar is an independent component before assembly, which simplifies the manufacture of both the pressure pipe and the sensor pipe.

Obviously, other changes are possible to the embodiment types shown or described, without changing the intent of the invention. Although the regulating device 1 is especially suitable as a simple operating proportional magnet which regulates the stroke of the rotor 29 using a distance measuring system, the regulating device 1 can also be used as a solenoid, whereby the distance measuring system is only used to indicate the position. In addition, the benefits of the regulating device can also be achieved if a double acting construction, namely a double stroke magnet is used instead of a simple acting construction.

1. Electromagnetic regulating device (1) for a hydraulic control valve with a housing (14, 15, 32), which has a rotor of a electromagnet in a pressure pipe (2), with a distance measuring system (6) which determines the stroke of the rotor, where the pressure pipe (2) has a central thread (3) at one end to fasten it to the control valve, and is comprised of a rotor conduit (7) and a sensor pipe (8), which is fixed and tightly connected to it, where the rotor conduit (7) holds the rotor and carries a magnet coil (5) and the sensor pipe (8) has a sensor coil (21) to determine the distance, as well as fastening means for the components straddling the pressure pipe (2); characterized in that there is a collar (13) to hold the components arranged on the rotor conduit (7) in the region of the end of the rotor conduit (7) that is turned toward the sensor pipe (8), that is fixed to the rotor conduit (7) and extends passed it.

2. Electromagnet regulating device based on claim 1, characterized in that the collar (13) is one piece with a bushing.

3. Electromagnet regulating device based on claim 2, characterized in that the bushing is at least partially arranged on the rotor conduit (7).

4. Electromagnet regulating device based on claim 2, characterized in that the bushing is at least partially arranged in the rotor conduit (7).

5. Electromagnet regulating device based on claim 1, characterized in that the collar (13) is one piece with the sensor pipe (8).

6. Electromagnetic regulating device based on one of the claims 1 to 5, characterized in that the collar (13) has at least one device (25), which corresponds with an assembly tool in such a manner, that a fixed but removable connection can be made between the collar (13) and the assembly tool for assembly.

7. Electromagnetic regulating device based on one of the claims 1 to 6, characterized in that an outer diameter of the distance measuring system (6) is formed in such a manner that the assembly tool can be conducted using this, and can be attached to the collar (13).

8. Electromagnet regulating device based on claim 1, characterized in that the collar (13) is one piece with the rotor conduit (7).

9. Electromagnetic regulating device based on one of the claims 1 to 8, characterized in that there is a spring (16) for tolerance compensation between the side of the collar (13) turned towards the magnetic coil (5) and the housing (14, 15, 32).

10. Electromagnetic regulating device based on one of the claims 1 to 9, characterized in that a seal between the magnetic coil (5) and the housing (14, 15, 32) is formed using inclines (31A, 31B) corresponding to each other, whereby the angles of the inclines (31A, 31B) are provided so that there is a sealing line contact between inclines (31A, 31B) when the regulating device (1) is assembled.

11. Electromagnetic regulating device based on the claims 1 to 10, characterized in that the pressure pipe (2) has a recess (36) in the area of the magnetic coil (5) on its outer side, into which the magnetic coil (5) extends with a projection (37) formed on its inner side, turned towards the pressure pipe.
